(19) United States
(12) Patent Application Publication
(10) Pub. No.: US 2015/0205400 A1
(43) Pub. Date: Jul. 23, 2015

(54) Grip Detection

(71) Applicant: MICROSOFT CORPORATION, Redmond, WA (US)

(72) Inventors: Dan Hwang, New Castle, WA (US); Muhammad Usman, Bellevue, WA (US); Scott Greenlay, Redmond, WA (US); Moshe Sapir, Seattle, WA (US)

(73) Assignee: MICROSOFT CORPORATION, Redmond, WA (US)

(21) Appl. No.: 14/160,276

(22) Filed: Jan. 21, 2014

(51) Int. Cl. G06F 3/044; G06T 3/60

(52) U.S. Cl. CPC G06F 3/044; G06T 3/60

(57) ABSTRACT

Example apparatus and methods detect how a portable (e.g., handheld) device (e.g., phone, tablet) is gripped (e.g., held, supported). Detecting the grip may include detecting and characterizing touch points for fingers, thumbs, palms, or surfaces that are involved in supporting and positioning the apparatus. Example apparatus and methods may determine whether and how an apparatus is being held and then may exercise control based on the grip detection. For example, a display on an input/output interface may be reconfigured, physical controls (e.g., push buttons) on the apparatus may be remapped, user interface elements may be repositioned, resized, or repurposed, portions of the input/output interface may be desensitized or hyper-sensitized, virtual controls may be remapped, or other actions may be taken. Touch sensors may detect the pressure with which a smart phone is being gripped and produce control events (e.g., on/off, louder/quieter, brighter/dimmer, press and hold) based on the pressure.

### BACKGROUND

Touch-sensitive and hover-sensitive input/output interfaces typically report the presence of an object using an (x,y) co-ordinate for a touch-sensitive screen and an (x,y,z) co-ordinate for a hover-sensitive screen. However, apparatus with touch-sensitive and hover-sensitive screens may only report touches or hovers associated with the input/output interface (e.g., display screen). While the display screen typically consumes over ninety percent of the front surface of an apparatus, the front surface of the apparatus is less than fifty percent of the surface area of the apparatus. For example, touch events that occur on the back or sides of the apparatus, or at any location on the apparatus that is not the display screen, may go unreported. Thus, conventional apparatus may not even consider information from over half the available surface area of a handheld device, which may limit the quality of the user experience.

An apparatus with a touch and hover-sensitive input/output interface may take an action based on an event generated by the input/output interface. For example, when a hover enter event occurs a hover point may be established, when a touch occurs a touch event may be generated and a touch point may be established, and when a gesture occurs, a gesture control event may be generated. Conventionally, the hover point, touch point, and control event may have been established or generated without considering context information available for the apparatus. Some context (e.g., orientation) may be inferred from, for example, accelerometer information produced by the apparatus. However, users are familiar with the frustration of an incorrect inference causing their smart phone to insist on presenting information in landscape mode when the user would prefer having the information presented in portrait mode. Users are also familiar with the frustration of not being able to operate their smart phone with one hand and with inadvertent touch events being generated by, for example, the palm of their hand while the user moves their thumb over the input/output interface.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example methods and apparatus are directed towards detecting and responding to a grip being used to interact with a portable (e.g., handheld) device (e.g., phone, tablet) having a touch or hover-sensitive input/output interface. The grip may be determined based, at least in part, on actual measurements from additional sensors located on or in the device. The sensors may identify one or more contact points associated with objects that are touching the device. The sensors may be touch sensors that are located, for example, on the front of the apparatus beyond the boundaries of an input/output interface (e.g., display screen), on the sides of the device, or on the back of the device. The sensors may detect, for example, where the fingers, thumb, or palm are positioned, whether the device is lying on another surface, whether the device is being supported all along one edge by a surface, or other information. The sensors may also detect, for example, the pressure being exerted by the fingers, thumb, or palm. A determination concerning whether the device is being held with both hands, in one hand, or by no hands may be made based, at least in part, on the positions and associated pressures of the fingers, thumb, palm. or surfaces with which the device is interacting. A determination may also be made concerning an orientation at which the device is being held or supported and whether the input/output interface should operate in a portrait orientation or landscape orientation.

Some embodiments may include logics that detect grip contact points and then configure the apparatus based on the grip. For example, the functions of physical controls (e.g., buttons, swipe areas) or virtual controls (e.g., user interface elements displayed on input/output interface) may be remapped based on the grip or orientation. For example, after detecting the position of the thumb, a physical button located on an edge closest to the thumb may be mapped to a most likely to be used function (e.g., select) while a physical button located on an edge furthest from the thumb may be mapped to a less likely to be used function (e.g., delete). The sensors may detect actions like touches, squeezes, swipes, or other interactions. The logics may interpret the actions differently based on the grip or orientation. For example, when the device is operating in a portrait mode and playing a song, brushing a thumb up or down the edge of the device away from the palm may increase or decrease the volume of the song. Thus, example apparatus and methods use sensors located on portions of the device other than just the input/output display interface to collect more information than conventional devices and then reconfigure the device, an edge interface on the device, an input/output display interface on the device, or an application running on the device based on the additional information.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example hover-sensitive device.

FIG. 2 illustrates an example hover sensitive input/output interface.

FIG. 3 illustrates an example apparatus having an input/output interface and an edge space.

FIG. 4 illustrates an example apparatus having an input/output interface, edge spaces, and a back space.

FIG. 5 illustrates an example apparatus that has detected a right hand hold in the portrait orientation.

FIG. 6 illustrates an example apparatus that has detected a left hand hold in the portrait orientation.

FIG. 7 illustrates an example apparatus that has detected a right hand hold in the landscape orientation.

FIG. 8 illustrates an example apparatus that has detected a left hand hold in the landscape orientation.

FIG. 9 illustrates an example apparatus that has detected a two hand hold in the landscape orientation.

FIG. 10 illustrates an apparatus where sensors on an input/output interface co-operate with sensors on edge interfaces to make a grip detection.

FIG. 11 illustrates an apparatus before a grip detection has occurred.

FIG. 12 illustrates an apparatus after a grip detection has occurred.

FIG. 13 illustrates a gesture that begins on a hover-sensitive input/output interface, continues onto a touch-sensitive edge interface, and then returns to the hover-sensitive input/output interface.

FIG. 14 illustrates a user interface element being repositioned from an input/output interface to the edge interface.

FIG. 15 illustrates an example method associated with detecting and responding to a grip.

FIG. 16 illustrates an example method associated with detecting and responding to a grip.

FIG. 17 illustrates an example apparatus configured to detect and respond to a grip.

FIG. 18 illustrates an example apparatus configured to detect and respond to a grip.

FIG. 19 illustrates an example cloud operating environment in which an apparatus configured to detect and respond to grip may operate.

FIG. 20 is a system diagram depicting an exemplary mobile communication device configured to process grip information.

### DETAILED DESCRIPTION

Example apparatus and methods concern detecting how a portable (e.g., handheld) device (e.g., phone, tablet) is being gripped (e.g., held, supported). Detecting the grip may include, for example, detecting touch points for fingers, thumbs, or palms that are involved in gripping the apparatus. Detecting the grip may also include determining that the device is resting on a surface (e.g., lying on a table), or being supported hands-free (e.g., held in a cradle). Example apparatus and methods may determine whether and how an apparatus is being held and then may exercise control based on the grip detection. For example, a display on an input/output interface may be reconfigured, physical controls (e.g., push buttons) may be remapped, user interface elements may be repositioned, portions of the input/output interface may be de-sensitized, or virtual controls may be remapped based on the grip.

Touch technology is used to determine where an apparatus is being touched. Example methods and apparatus may include touch sensors on various locations including the front of an apparatus, on the edges (e.g., top, bottom, left side, right side) of an apparatus, or on the back of an apparatus. Hover technology is used to detect an object in a hover-space. “Hover technology” and “hover-sensitive” refer to sensing an object spaced away from (e.g., not touching) yet in close proximity to a display in an electronic device. “Close proximity” may mean, for example, beyond 1 mm but within 1 cm, beyond 0.1 mm but within 10 cm, or other combinations of ranges. Being in close proximity includes being within a range where a proximity detector can detect and characterize an object in the hover-space. The device may be, for example, a phone, a tablet computer, a computer, or other device. Hover technology may depend on a proximity detector(s) associated with the device that is hover-sensitive. Example apparatus may include both touch sensors and proximity detector(s).

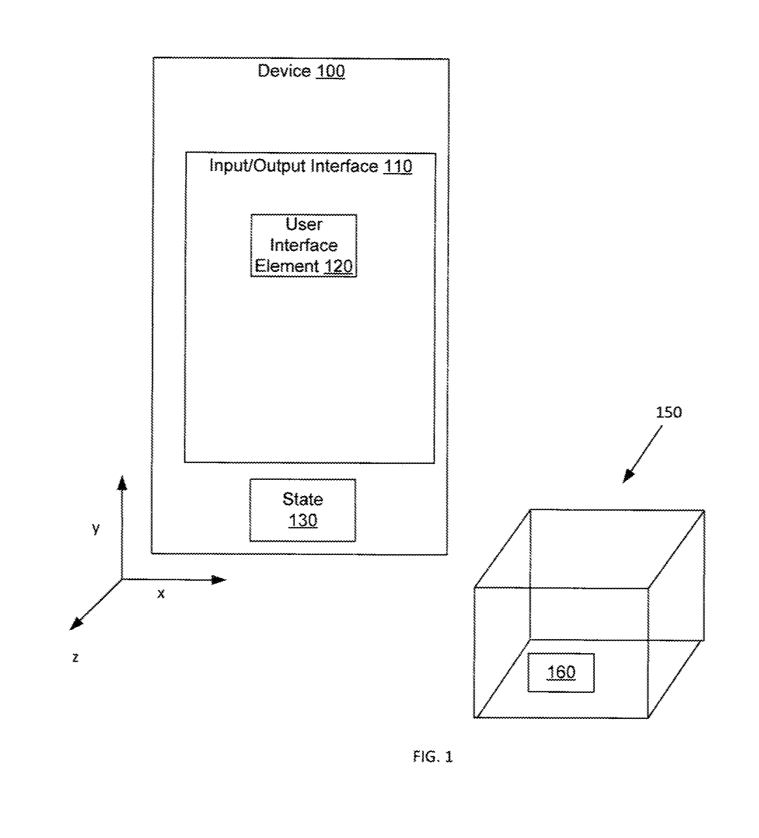

FIG. 1 illustrates an example hover-sensitive device 100. Device 100 includes an input/output (i/o) interface 110 (e.g., display). I/O interface 110 is hover-sensitive. I/O interface 110 may display a set of items including, for example, a user interface element 120. User interface elements may be used to display information and to receive user interactions. Hover user interactions may be performed in the hover-space 150 without touching the device 100. Touch interactions may be performed by touching the device 100 by, for example, touching the i/o interface 110. Conventionally, interactions occurring on the input/output interface 110 may be detected and responded to. Interactions (e.g., touches, swipes, taps) with portions of device 100 other than that input/output interface 110 may have been ignored.

Device 100 or i/o interface 110 may store state 130 about the user interface element 120, other items that are displayed, or other sensors positioned on device 100. The state 130 of the user interface element 120 may depend on the orientation of device 100. The state information may be saved in a computer memory.

The device 100 may include a proximity detector that detects when an object (e.g., digit, pencil, stylus with capacitive tip) is close to but not touching the i/o interface 110. The proximity detector may identify the location (x, y, z) of an object (e.g., finger) 160 in the three-dimensional hover-space 150, where x and y are in a plane parallel to the interface 110 and z is perpendicular to the interface 110. The proximity detector may also identify other attributes of the object 160 including, for example, how close the object is to the i/o interface (e.g., z distance), the speed with which the object 160 is moving in the hover-space 150, the pitch, roll, yaw of the object 160 with respect to the hover-space 150, the direction in which the object 160 is moving with respect to the hover-space 150 or device 100 (e.g., approaching, retreating), an angle at which the object 160 is interacting with the device 100, or other attributes of the object 160. While a single object 160 is illustrated, the proximity detector may detect and characterize more than one object in the hover-space 150.

In different examples, the proximity detector may use active or passive systems. Far example, the proximity detector may use sensing technologies including, but not limited to, capacitive, electric field, inductive. Hall effect, Reed effect, Eddy current, magneto resistive, optical shadow, optical visual light, optical infrared (IR), optical color recognition, ultrasonic, acoustic emission, radar, heat, sonar, conductive, and resistive technologies. Active systems may include, among other systems, infrared or ultrasonic systems. Passive systems may include, among other systems, capacitive or optical shadow systems. In one embodiment, when the proximity detector uses capacitive technology, the detector may include a set of capacitive sensing nodes to detect a capacitance change in the hover-space 150. The capacitance change may be caused, for example, by a digit(s) (e.g., finger, thumb) or other object(s) (e.g., pen, capacitive stylus) that comes within the detection range of the capacitive sensing nodes.

In another embodiment, when the proximity detector uses infrared light, the proximity detector may transmit infrared light and detect reflections of that light from an object within the detection range (e.g., in the hover-space 150) of the infrared sensors. Similarly, when the proximity detector uses ultrasonic sound, the proximity detector may transmit a sound into the hover-space 150 and then measure the echoes of the sounds. In another embodiment, when the proximity detector uses a photo-detector, the proximity detector may track changes in light intensity. Increases in intensity may reveal the removal of an object from the hover-space 150 while decreases in intensity may reveal the entry of an object into the hover-space 150.

In general, a proximity detector includes a set of proximity sensors that generate a set of sensing fields in the hover-space 150 associated with the i/o interface 110. The proximity detector generates a signal when an object is detected in the hover-space 150. In one embodiment, a single sensing field may be employed. In other embodiments, two or more sensing fields may be employed. In one embodiment, a single technology may be used to detect or characterize the object 160 in the hover-space 150. In another embodiment, a combination of two or more technologies may be used to detect or characterize the object 160 in the hover-space 150.

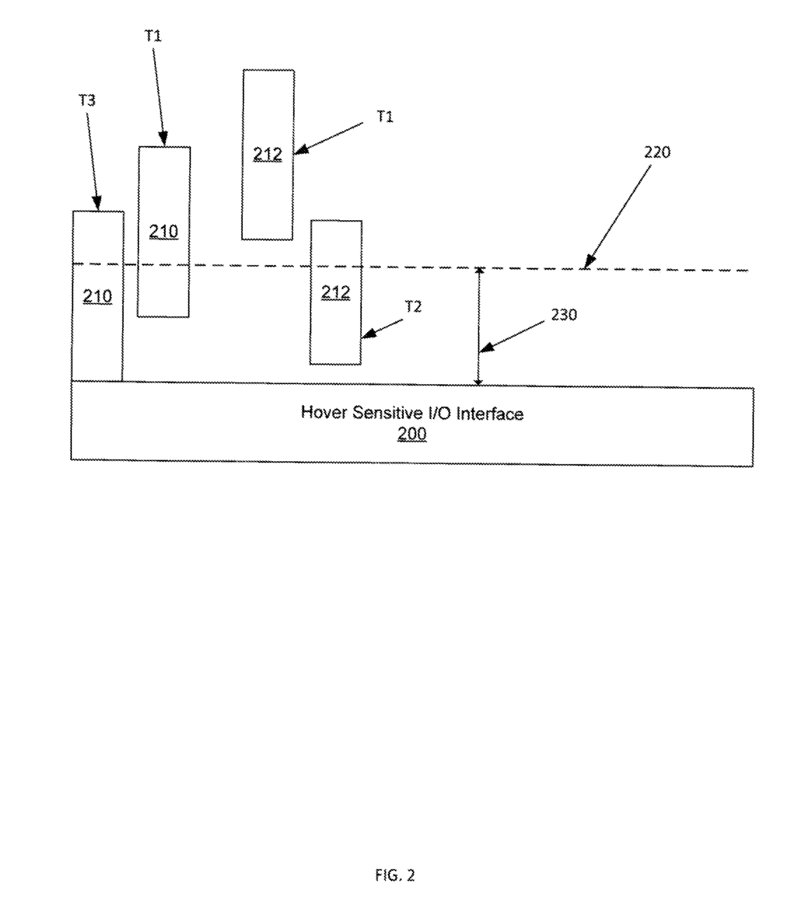

FIG. 2 illustrates a hover-sensitive i/o interface 200. Line 220 represents the outer limit of the hover-space associated with hover-sensitive i/o interface 200. Line 220 is positioned at a distance 230 from i/o interface 200. Distance 230 and thus line 220 may have different dimensions and positions for different apparatus depending, for example, on the proximity detection technology used by a device that supports i/o interface 200.

Example apparatus and methods may identify objects located in the hover-space bounded by i/o interface 200 and line 220. Example apparatus and methods may also identify items that touch i/o interface 200. For example, at a first time 11, an object 210 may be detectable in the hover-space and an object 212 may not be detectable in the hover-space. At a second time T2, object 212 may have entered the hover-space and may actually come closer to the i/o interface 200 than object 210. At a third time T3, object 210 may come in contact with i/o interface 200. When an object enters or exits the hover space an event may be generated. When an object moves in the hover space an event may be generated. When an object touches the i/o interface 200 an event may be generated. When an object transitions from touching the i/o interface 200 to not touching the i/o interface 200 but remaining in the hover space an event may be generated. Example apparatus and methods may interact with events at this granular level (e.g., hover enter, hover exit, hover move, hover to touch transition, touch to hover transition) or may interact with events at a higher granularity (e.g., hover gesture). Generating an event may include, for example, making a function call, producing an interrupt, updating a value in a computer memory, updating a value in a register, sending a message to a service, sending a signal, or other action that identifies that an action has occurred. Generating an event may also include providing descriptive data about the event. For example, a location where the event occurred, a title of the event, and an object involved in the object may be identified.

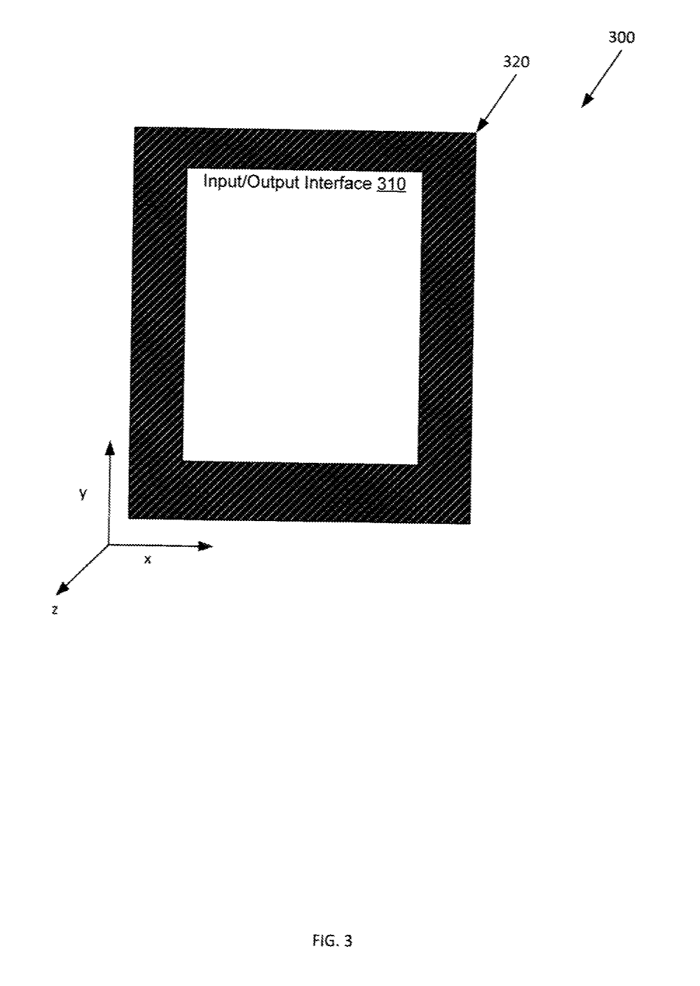

FIG. 3 illustrates an example apparatus 300 that is configured with an input/output interface 310 and edge space 320. Conventionally, the hover and touch events described in connection with the touch and hover-sensitive apparatus described in FIGS. 1 and 2 have occurred only in the region associated with the input/output interface 310 (e.g., display). However, an apparatus 300 may also include region 320 that is not part of the input/output interface 310. The unused space may include more than just region 320 located on the front of apparatus 300.

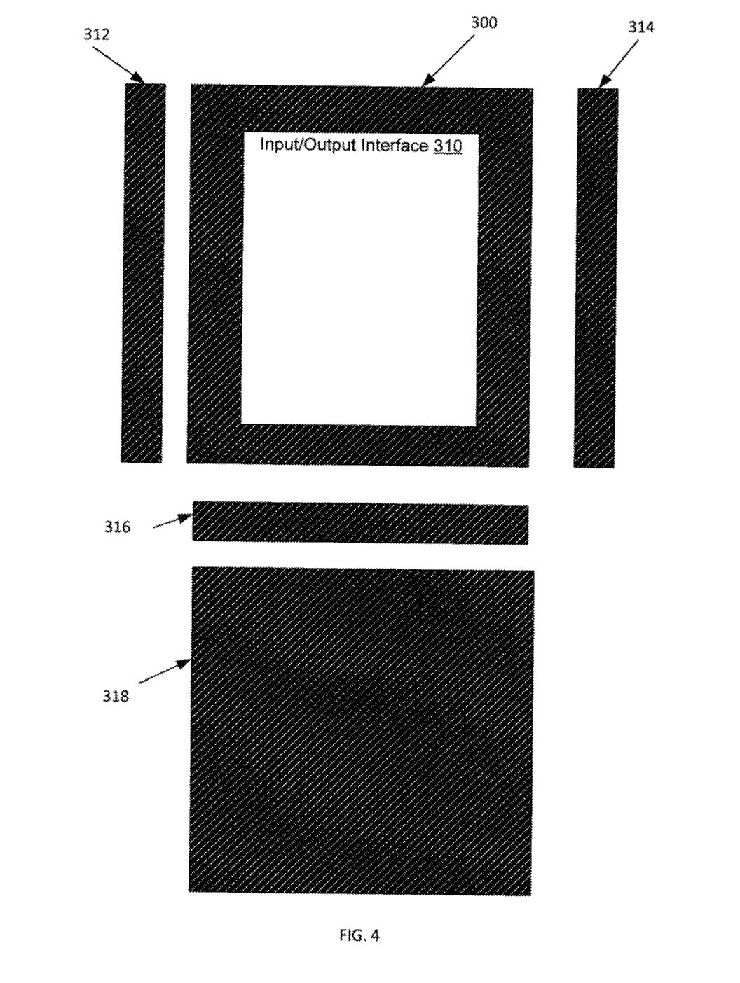

FIG. 4 illustrates a front view of apparatus 300, a view of the left edge 312 of apparatus 300, a view of the right edge 314 of apparatus 300, a view of the bottom edge 316 of apparatus 300, and a view of the back 318 of apparatus 300. Conventionally there may not have been touch sensors located on the edges 312, 314, the bottom 316, or the back 318. To the extent that conventional devices may have included touch sensors, those sensors may not have been used to detect how an apparatus is being gripped and may not have provided information upon which reconfiguration decisions and control events may be generated.

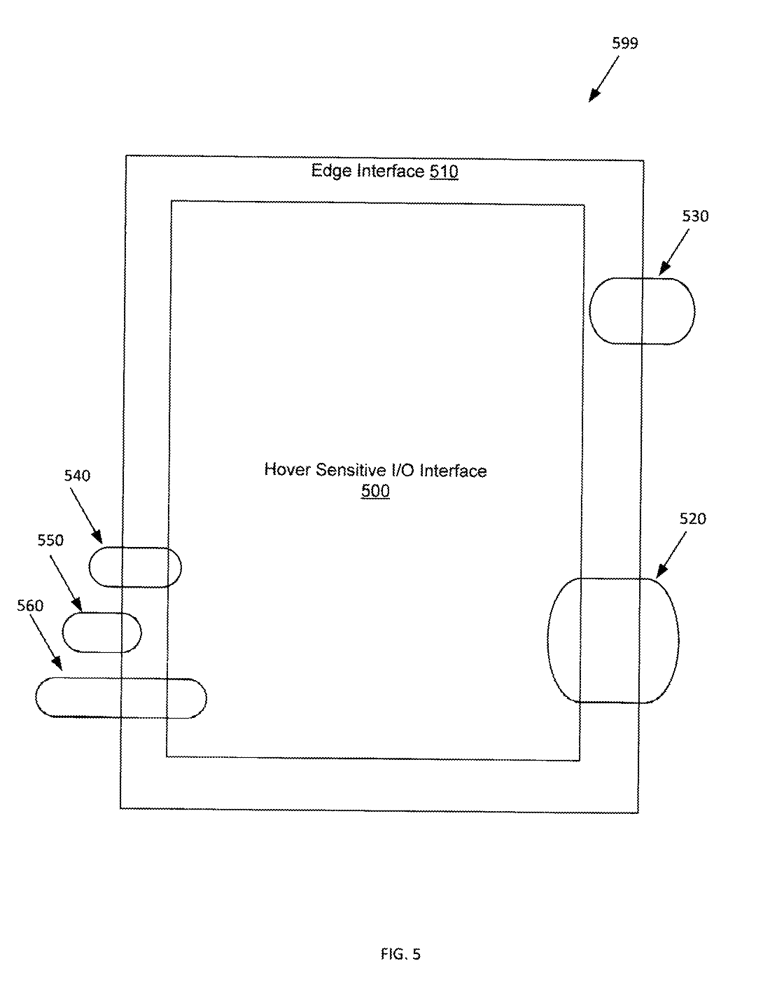

FIG. 5 illustrates an example apparatus 599 that has detected a right hand hold in the portrait orientation, Apparatus 599 includes an interface 500 that may be touch or hover-sensitive. Apparatus 599 also includes an edge interface 510 that is touch sensitive. Edge interface 510 may detect, for example, the location of palm 520, thumb 530, and fingers 540, 550, and 560. Interface 500 may also detect, for example, palm 520 and fingers 540 and 560. In one embodiment, example apparatus and methods may identify the right hand portrait grip based on the touch points identified by edge interface 510. In another embodiment, example apparatus and methods may identify the right hand portrait grip based on the touch or hover points identified by i/o interface 500. In yet another embodiment, example apparatus and methods may identify the right hand portrait grip based on data from the edge interface 510 and the i/o interface 500. Edge interface 510 and i/o interface 500 may be separate machines, circuits, or systems that co-exist in apparatus 599. An edge interface (e.g., touch interface with no display) and an i/o interface (e.g., display) may share resources, circuits, or other elements of an apparatus, may communicate with each other, may send events to the same or different event handlers, or may interact in other ways.

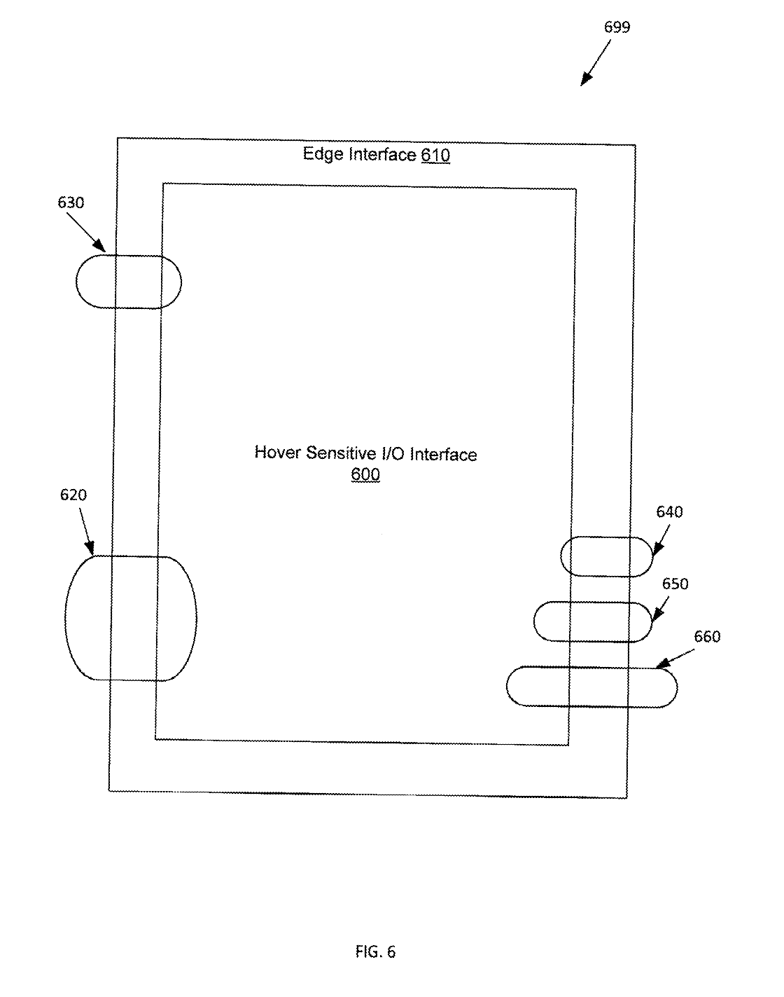

FIG. 6 illustrates an example apparatus 699 that has detected a left hand hold in the portrait orientation. Edge interface 610 may detect palm 620, thumb 630, and fingers 640, 650, and 660. Edge interface 610 may detect, for example, the locations where the edge interface 610 is being touched and the pressure with which the edge interface 610 is being touched. For example, finger 640 may be gripping the apparatus 690 with a first lighter pressure while finger 660 may be gripping the apparatus 699 with a second greater pressure. Edge interface 610 may also detect, for example, whether a touch point is moving along the edge interface 610 and whether the pressure associated with a touch point is constant, increasing, or decreasing. Thus, edge interface 610 may be able to detect events including, for example, a swipe along an edge, a squeeze of apparatus 699, a tap on edge interface 610, or other actions. Using sensors placed outside the i/o interface 600 facilitates increasing the surface area available for user interactions, which may improve the number and types of interactions that are possible with a handheld device. Using sensors that facilitate moving virtual controls to fingers instead of moving fingers to controls may facilitate using a handheld device with one hand.

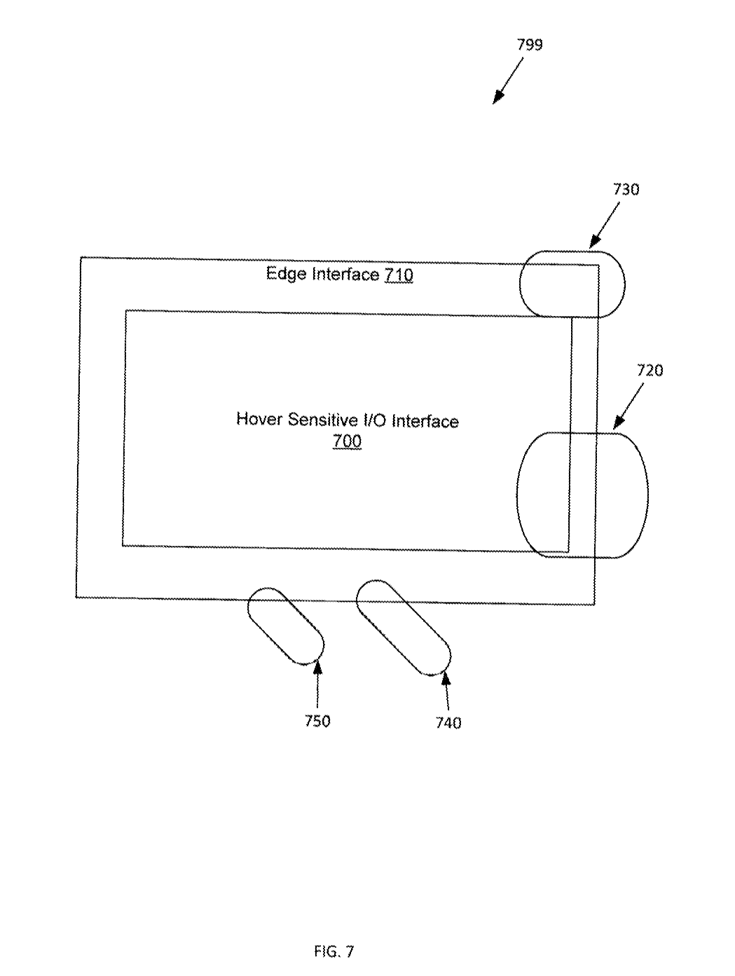

FIG. 7 illustrates an example apparatus 799 that has detected a right hand hold in the landscape orientation. Hover-sensitive i/o interface 700 may have detected palm 720 while edge interface 710 may have detected thumb 730, and fingers 740 and 750. Conventional apparatus may switch between portrait and landscape mode based, for example, on information provided by an accelerometer or gyroscope or other inertial or positional sensor. While these conventional systems may provide some functionality, users are familiar with flipping their wrists and holding their hands at uncomfortable angles to make the portrait/landscape presentation agree with their viewing configuration. Example apparatus and methods may make a portrait/landscape decision based, at least in part, on the locations of the palm 720, thumb 730, or fingers 750 and 740. In one embodiment, a user may grip apparatus 799 to establish one orientation, and then perform an action (e.g., squeeze apparatus 799) to “lock in” the desired orientation. This may prevent the frustrating experience of having a display re-orient to or from portrait/landscape when, for example, a user who was lying down sits up or rolls over.

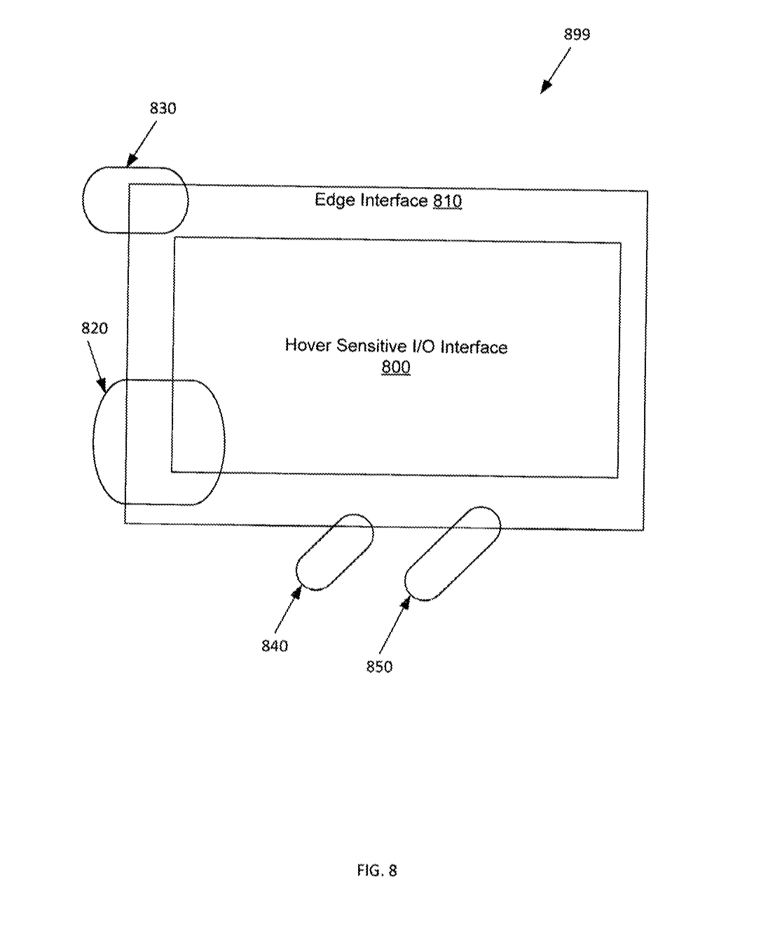

FIG. 8 illustrates an example apparatus 899 that has detected a left hand hold in the landscape orientation. Consider a situation where a user grips their smart phone in their left hand and then lays the phone down on their desk. Example apparatus may determine a left hand landscape hold based on the position of the palm 820, the thumb 830, and fingers 840 and 850. Example apparatus and methods may then determine that apparatus 899 is not being held at all, but rather is in a hands free situation where apparatus 899 is lying fiat on its back on a surface. Touch sensors on edge interface 810, which may include touch sensors on the sides of apparatus 899 and even the back of apparatus 899, may determine an initial orientation from an initial grip and then may maintain or change that orientation based on a subsequent grip. In the example where a user picks up their phone with their left hand in the landscape orientation and then sets their phone down flat on its back on a surface, example apparatus may maintain the left hand landscape grip state even though the smart phone is no longer being held in either hand.

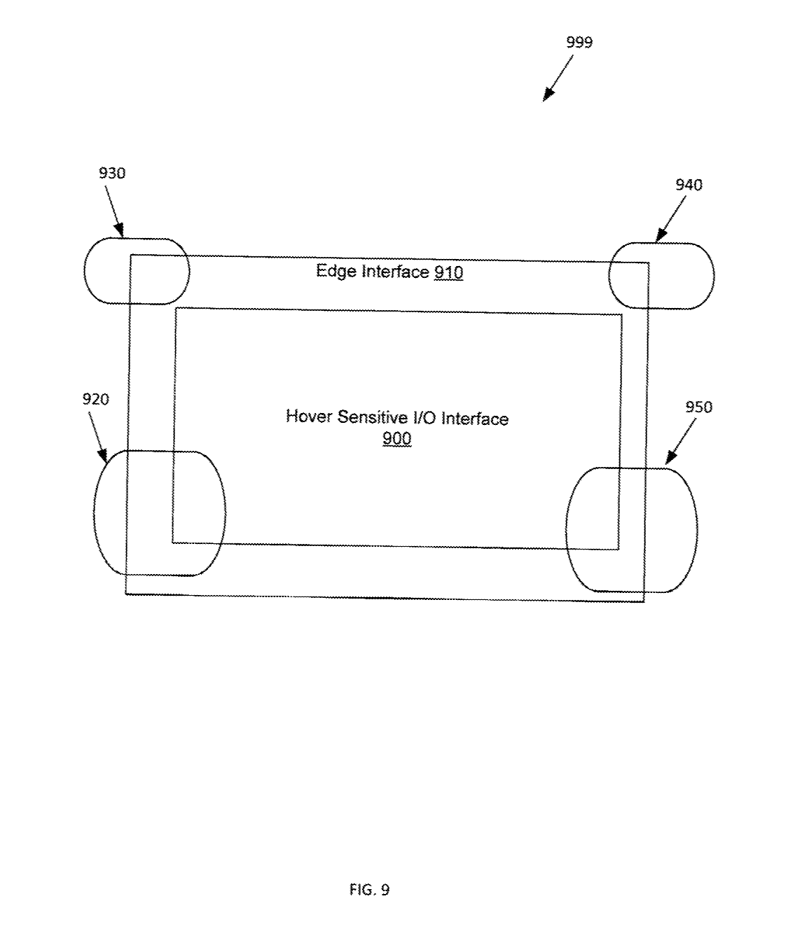

FIG. 9 illustrates an example apparatus 999 that has detected both hands holding the apparatus 999 in the landscape orientation. Hover-sensitive i/o interface 900 and edge interface 910 may have detected hover or touch events associated with left palm 920, left thumb 930, right palm 950, and right thumb 940. Based on the relative positions of the thumbs and palms, example methods and apparatus may determine that the apparatus 999 is being held in the landscape orientation with both hands. While being held in both hands, a user may, for example, interact with hover-sensitive i/o interface 900 using both thumbs. In conventional apparatus, the entire surface of hover-sensitive i/o interface 900 may have the same sensitivity to touch or hover events. Example apparatus and methods may determine where thumbs 930 and 940 are located and may selectively increase the sensitivity of regions most readily accessible to thumbs 930 and 940. In conventional apparatus, the areas under palms 920 and 950 may produce inadvertent touch or hover events on hover-sensitive i/o interface 900. Example apparatus may, therefore, de-sensitize hover-sensitive i/o interface 900 in regions associated with palms 920 and 950. Therefore, inadvertent touches or hovers may be avoided.

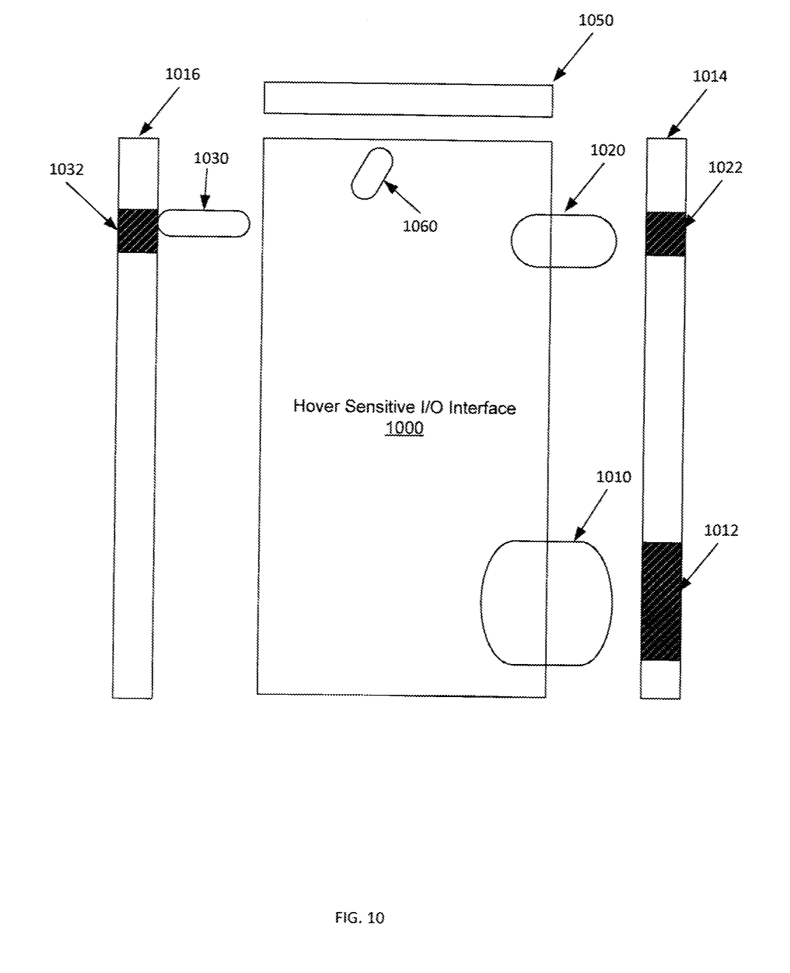

FIG. 10 illustrates an apparatus where sensors on an input/output interface 1000 co-operate with sensors on edge interfaces to make a grip detection. I/O interface 1000 may be, for example, a display. Palm 1010 may be touching right side 1014 at location 1012. Palm 1010 may also be detected by hover-sensitive i/o interface 1000. Thumb 1020 may be touching right side 1014 at location 1022. Thumb 1020 may also be detected by interface 1000. Finger 1060 may be near but not touching top 1050 and thus not detected by an edge interface but may be detected by interface 1000. Finger 1030 may be touching left side 1036 at location 1032 but may not be detected by interface 1000. Based on the combination of inputs from the interface 1000 and from touch sensors on right side 1014, top 1050 and left side 1016, a determination may be made about which hand is holding the apparatus and in which orientation. Example apparatus and methods may then (re)arrange user interface elements on interface 1000, (re)configure controls on side 1014, side 1016, or top 1050, or take other actions.

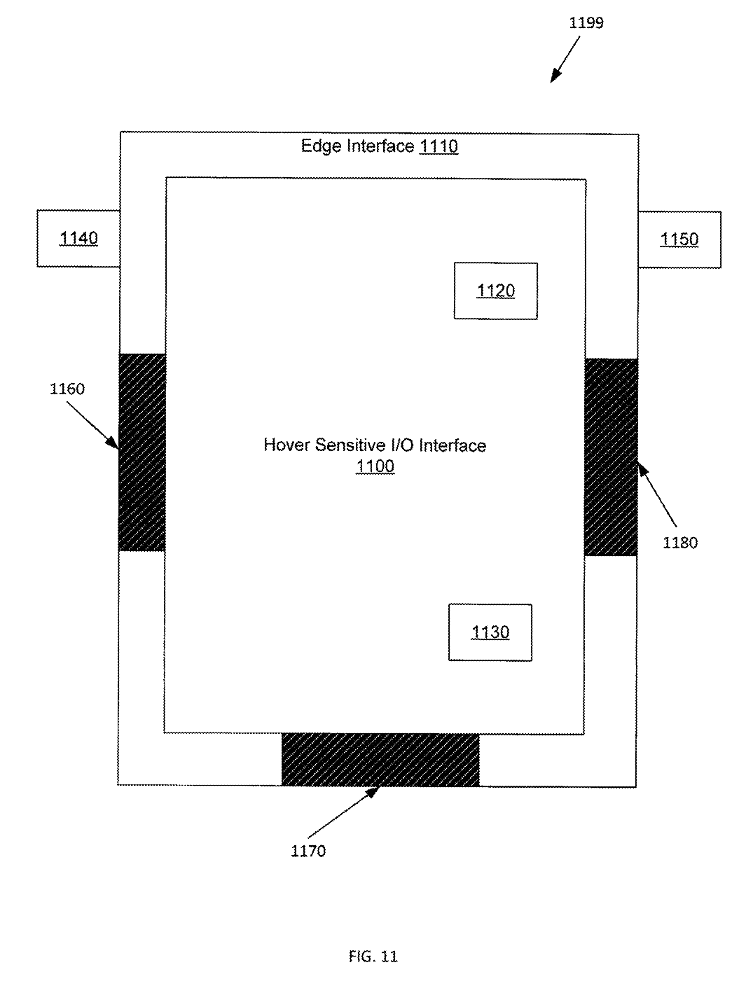

FIG. 11 illustrates an apparatus 1199 before a grip detection has occurred. Apparatus 1199 may have an edge interface 1110 with control regions 1160, 1170, and 1180. Before a grip is detected, the control regions 1160, 1170, and 1180 may be configured to perform pre-defined functions in response to experiencing pre-defined actions. For example, control region 1170 may, by default, adjust the volume of apparatus 1199 based on a swiping action where a swipe left increases volume and a swipe right decreases volume. Apparatus 1199 may also include a hover-sensitive i/o interface 1100 that displays user interface elements. For example, user interface element 1120 may be an “answer” button and user interface element 1130 may be an “ignore” button used for handling an incoming phone call. Apparatus 1199 may also include a physical button 1140 located on the left side and a physical button 1150 located on the right side. Presses of button 1140 or button 1150 may cause default actions that assume a right hand grip in the portrait configuration. Having physical buttons, control regions, or user interface elements that perform default actions based on pre-determined assumptions may produce a sub-optimal user interaction experience. Thus, example apparatus and methods may reconfigure apparatus 1199 based on a grip detection.

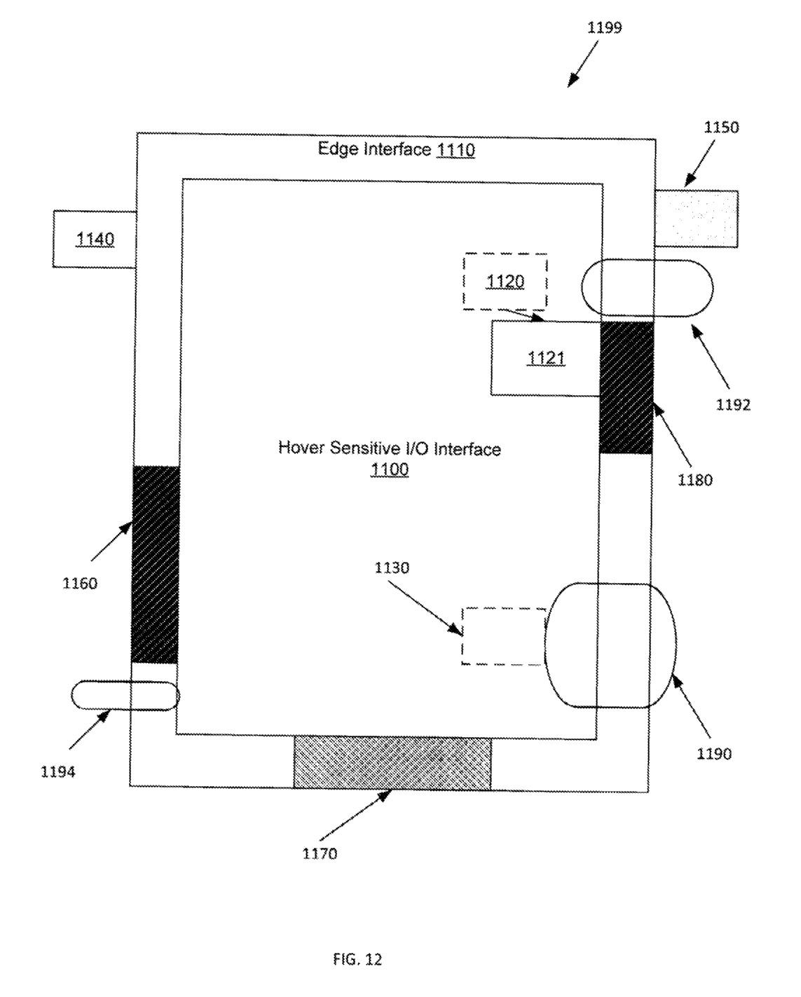

FIG. 12 illustrates apparatus 1199 after a grip detection has occurred. Palm 1190 has been detected in the lower right hand corner, thumb 1192 has been detected in the upper right hand corner, and finger 1194 has been detected in the lower left corner. From these positions, a determination may be made that apparatus 1199 is being held in the portrait orientation by the right hand. While understanding which hand is holding apparatus 1199 in which orientation is interesting and useful, reconfiguring apparatus 1199 based on the determination may improve the user interaction experience.

For example, conventional apparatus may produce inadvertent touches of user interface element 1130 by palm 1190. Therefore, in one embodiment, example apparatus and methods may desensitize interface 1100 in the region of palm 1190. In another embodiment, example apparatus and methods may remove or disable user interface element 1130. Thus, inadvertent touches may be avoided.

User interface element 1120 may be enlarged and moved to location 1121 based on the position of thumb 1192. Additionally, control region 1180 may be repositioned higher on the right side based on the position of thumb 1192. Repositioning region 1180 may be performed by selecting which touch sensors on the right side of apparatus are active. In one embodiment, the right side of apparatus 1199 may have N sensors, N being an integer. The N sensors may be distributed along the right side. Which sensors, if any, are active may be determined, at least in part, by the location of thumb 1192. For example, if there are sixteen sensors placed along the right side, sensors five through nine may be active in region 1180 based on the location of thumb 1192.

Button 1150 may be deactivated based on the position of thumb 1192. It may difficult, if even possible at all, for a user to maintain their grip on apparatus 1199 and touch button 1150 with thumb 1192. Since the button may be useless when apparatus 1199 is held in the right hand in the portrait orientation, example apparatus and methods may disable button 1150. Conversely, button 1140 may be reconfigured to perform a function based on the right hand grip and portrait orientation. For example, in a default configuration, either button 1150 or button 1110 may cause the interface 1100 to go to sleep. In a right hand portrait grip, button 1150 may be disabled and button 1140 may retain the functionality.

Consider a smartphone that has a single button on each of its four edges. One embodiment may detect the hand with which the smartphone is being held and the orientation in which the smartphone is being held. The embodiment may then cause three of the four buttons to be inactive and may cause the button located on the “top” edge of the smartphone to function as the on/off button. Which edge is the “top” edge may be determined, for example, by the left/right grip detected and the portrait/landscape orientation detected. Additionally or alternatively, the smartphone may have touch sensitive regions on all four edges. Three of the four regions may be inactivated and only the region on the “bottom” of the smartphone will be active. The active region may operate as a scroll control for the phone. In this embodiment, the user will always have the same functionality on the top and bottom regardless of which hand is holding the smartphone and regardless of which edge is “up” and which edge is “down.” This may improve the user interaction experience with the phone or other device (e.g., tablet).

Like region 1180 was moved up towards thumb 1192, region 1160 may be moved down towards finger 1194. Thus, the virtual controls that are provided by the edge interface 1110 may be (re)positioned based on the grip, orientation, or location of the hand gripping apparatus 1199. Additionally, user interface elements displayed on i/o interface 1100 may be (re)positioned, (re)sized, or (re)purposed based on the grip, orientation, or location of the hand gripping apparatus 1199. Consider a situation where a right hand portrait grip is established for apparatus 1199. The user may then prop the apparatus 1199 up against something. In this configuration, the user may still want the right hand portrait orientation and the resulting positions and functionalities for user interface element 1121, button 1140, and control regions 1160 and 1180. However, bottom region 1170 is constantly being “touched” by the surface upon which apparatus 1199 is resting. Therefore, example apparatus and methods may identify that apparatus 1199 is resting on a surface on an edge and disable touch interactions for that edge. In the example, region 1170 may be disabled. If the user picks up apparatus 1199, region 1170 may then be re-enabled.

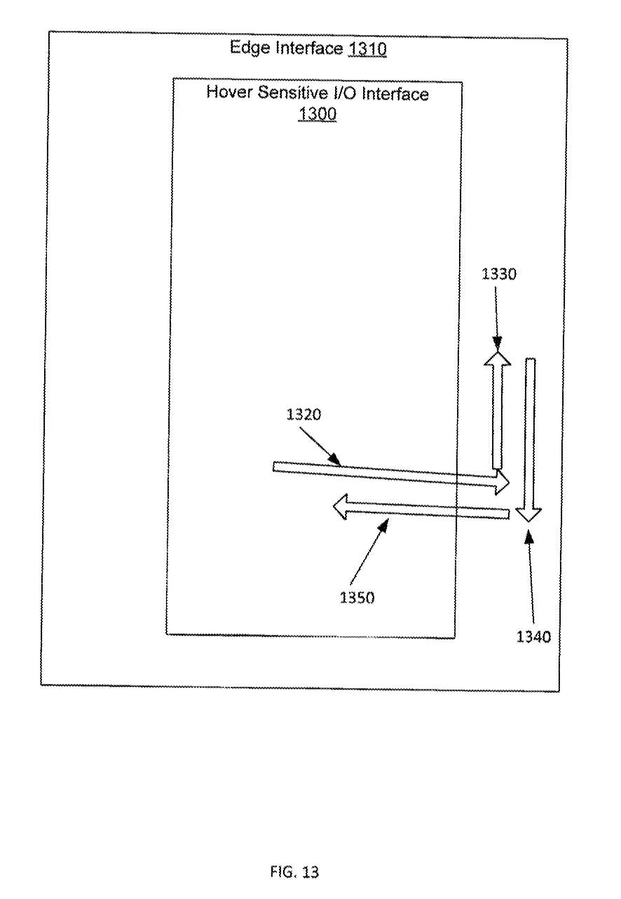

FIG. 13 illustrates a gesture that begins on a hover-sensitive input/output interface 1300, continues onto a touch-sensitive edge interface 1310, and then returns to the hover-sensitive input/output interface 1300. Conventional systems may only understand gestures that occur on the i/o interface 1300 or may only understand inputs from fixed controls (e.g., buttons) on their edges. Example apparatus and methods are not so limited. For example, a swipe 1320 may make an object appear to be dragged from interface 1300 to edge interface 1310. Swipes 1330 and 1340 may then be performed using touch sensors on edge interface 1310 and then swipe 1350 may appear to return the object back onto the interface 1300. This type of gesture may be useful in, for example, a painting application where a paint brush tip is dragged to the edge of the device, a swipe gesture is used to add more paint to the paint brush, and then the brush is returned to the display. The amount of paint added to the brush may depend on the length of the swipes on the edge interface 1310, on the number of swipes on the edge interface 1310, on the duration of the swipe on the edge interface 1310, or on other factors. Using the edge interface 1310 may facilitate saving display real estate on interface 1300, which may allow for an improved user experience.

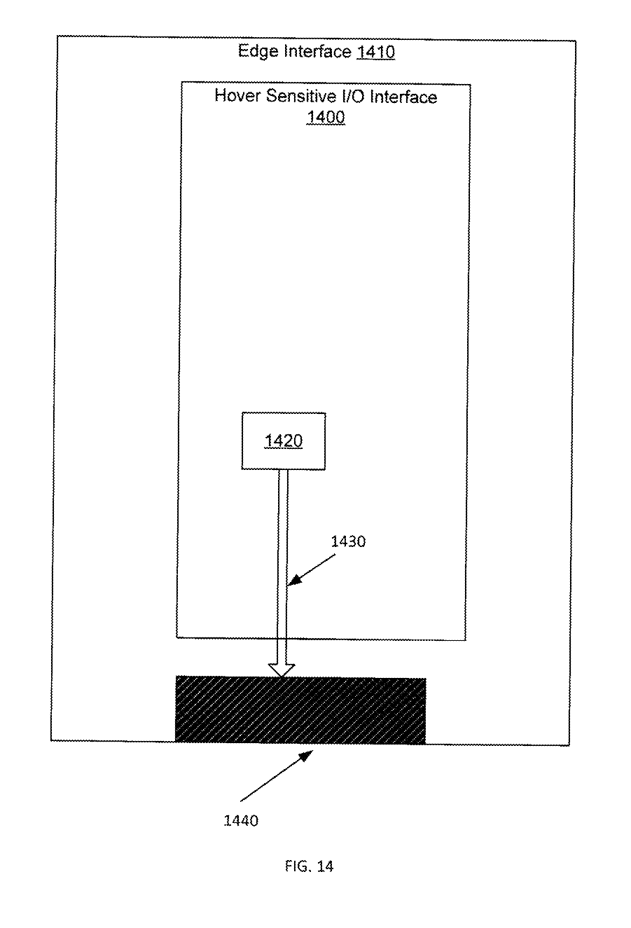

FIG. 14 illustrates a user interface element 1420 being repositioned from a hover-sensitive i/o interface 1400 to an edge interface 1410. Edge interface 1410 may have a control region 1440. Swipe 1430 may be used to inform edge interface 1410 that the action associated with a touch event on element 1420 is now to be performed when a touch or other interaction is detected in region 1440. Consider a video game with a displayed control that is repeatedly activated. A user may wish to have that function placed on the edge of the screen so that the game can be played with one hand, rather than having to hold the device in one hand and tap the control with a finger from the other hand. This may be useful in, for example, card games where a “deal” button is pressed frequently. This may also be useful in, for example, a “refresh” operation where a user wants to be able to update their display using just one hand.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

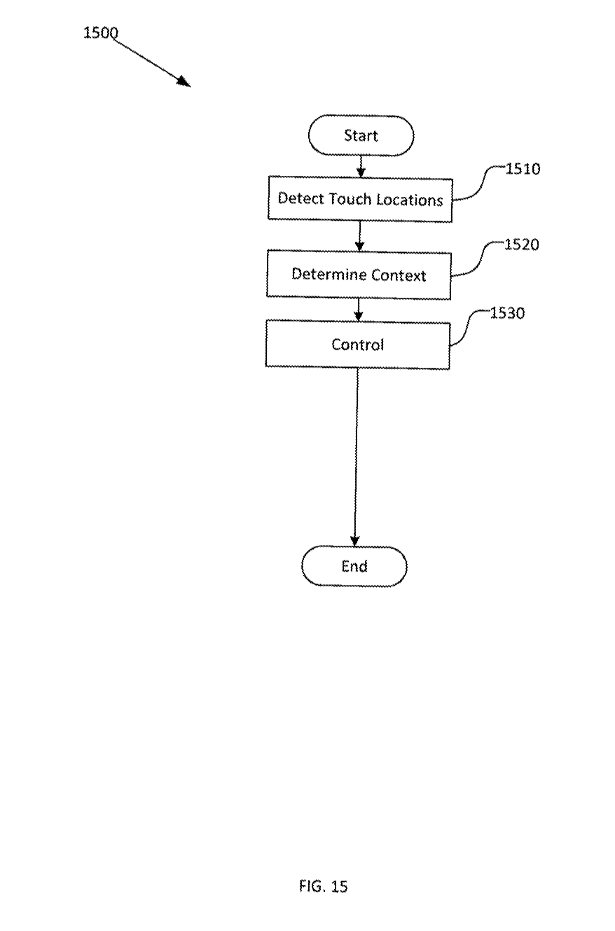

FIG. 15 illustrates an example method 1500 associated with detecting and responding to how an apparatus (e.g. phone, tablet), is being held. Method 1500 may include, at 1510, detecting locations at which an apparatus is being gripped. The apparatus may be, for example, a portable device (e.g., phone, tablet) that is configured with a touch or hover-sensitive display. Detecting the locations may include, for example, identifying a non-empty set of points where the apparatus is being gripped. In one embodiment, the set of points are identified from first information provided by the display. The set of points may, additionally or alternatively, be identified from second information provided by a plurality of touch sensors. The plurality of touch sensors may be located, for example, on the front, side, or back of the apparatus. In one embodiment, the touch sensors are not part of the touch or hover-sensitive display.

The first information may include, for example, a location, duration, or pressure associated with a touch location at which the apparatus is being gripped. The location, duration, and pressure may provide information about how an apparatus is being held. The first information may also identify a member of the set of points as being associated with a finger, a thumb, a palm, or a surface. The finger, thumb, and palm may be used when the apparatus is being held in a hand(s) while the surface may be used to support the apparatus in a hands-free mode.

An apparatus may be gripped, for example, in one hand, in two hands, or not at all (e.g., when resting on a desk, when in a cradle). Thus, method 1500 may also include, at 1520, determining a grip context based on the set of points. In one embodiment, the grip context identifies whether the apparatus is being gripped in a right hand, in a left hand, by a left hand and a right hand, or by no hands. The grip context may also provide information about the orientation in which the apparatus is being gripped. For example, the grip context may identify whether the apparatus is being gripped in a portrait orientation or in a landscape orientation.

Method 1500 may also include, at 1530, controlling the operation or appearance of the apparatus based, at least in part, on the grip context. In one embodiment, controlling the operation or appearance of the apparatus includes controlling the operation or appearance of the display. The display may be manipulated based, at least in part, on the set of points and the grip context. For example, the display may be reconfigured to account for the apparatus being held in the right or left hand or to account for the apparatus being held in a portrait or landscape orientation. Accounting for left/right hand and portrait/landscape orientation may include moving user elements, repurposing controls, or other actions.

While right/left and portrait/landscape may provide for gross control, the actual position of a finger, thumb, or palm, and the pressure with which a digit is holding the apparatus may also be considered to provide finer grained control. For example, a finger that is tightly gripping an apparatus is unlikely to be moved to press a control while a finger that is only lightly gripping the apparatus may be moved. Additionally, the thumb may be the most likely digit to move. Therefore, user interface elements on the display or non-displayed controls on a touch interface (e.g., edge interface, side interface, back interface) may be manipulated at a finer granularity based on location and pressure information.

In one embodiment, controlling the operation or appearance of the display includes manipulating a user interface element displayed on the display. The manipulation may include, for example, changing a size, shape, color, purpose, location, sensitivity, or other attribute of the user interface element. Controlling the appearance of the display may also include, for example, controlling whether the display presents information in a portrait or landscape orientation. In one embodiment, a user may be able to prevent the portrait/landscape orientation from being changed. Controlling the operation of the display may also include, for example, changing the sensitivity of a portion of the display. For example, the sensitivity of the display to touch or hover events may be increased near the thumb while the sensitivity of the display to touch or hover events may be decreased near the palm.

In one embodiment, controlling the operation of the apparatus includes controlling the operation of a physical control (e.g., button, touch region, swipe region) on the apparatus. The physical control may be part of the apparatus but not be part of the display. The control of the physical control may be based, at least in part, on the set of points and the grip context. For example, a phone may have a physical button on three of its four edges. Method 1500 may include controlling two of the buttons to be inactive and controlling the third of the buttons to operate as the on/off switch based on the right/left portrait/landscape determination.

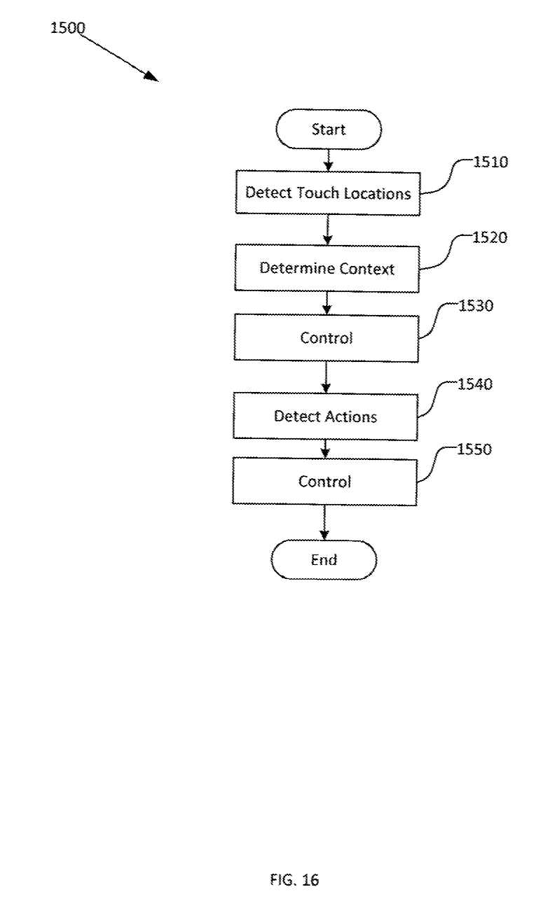

FIG. 16 illustrates another embodiment of method 1500. This embodiment of method 1500 facilitates detecting how an apparatus is being used while being held in a grip context. This embodiment of method 1500 includes, at 1540, detecting an action performed on a touch sensitive input region on the apparatus. The action may be, for example, a tap, a multi-tap, a swipe, a squeeze or other touch action. Recall that the touch sensitive input region is not part of the display. Part of detecting the action may include characterizing the action to produce a characterization data. The characterization data may describe, for example, a duration, location, pressure, direction, or other attribute of the action. The duration may control, for example, the intensity of an action associated with the touch. For example, a lengthy touch on a region that controls the volume of a speaker on the apparatus may produce a large change while a shorter touch may produce a smaller change. The location of the touch may determine, for example, what action is taken. For example, a touch on one side of the apparatus may cause the volume to increase while a touch on another side may cause the volume to decrease. The pressure may also control, for example, the intensity of an action. For example, a touch region may be associated with the volume of water to be sprayed from a virtual fire hose in a video game. The volume of water may be directly proportional to how hard the user presses or squeezes in the control region.

This embodiment of method 1500 also includes, at 1550, selectively controlling the apparatus based, at least in part, on the action or the characterization data. Controlling the apparatus may take different forms. In one embodiment, selectively controlling the apparatus may include controlling an appearance of the display. Controlling the appearance may include controlling, for example, whether the display presents information in portrait or landscape mode, where user interface elements are placed, what user interface elements look like, or other actions. In one embodiment, controlling the apparatus may include controlling an operation of the display. For example, the sensitivity of different regions of the display may be manipulated. In one embodiment, controlling the apparatus may include controlling an operation of the touch sensitive input region. For example, which touch sensors are active may be controlled. Additionally and/or alternatively, the function performed in response to different touches (e.g., tap, multi-tap, swipe, press and hold) in different regions may be controlled. For example, a control region may be repurposed to support a brushing action that provides a scroll wheel type functionality. In one embodiment, controlling the apparatus may also include controlling an application running on the apparatus. For example, the action may cause the application to pause, to terminate, to go from online to offline mode, or to take another action. In one embodiment, controlling the apparatus may include generating a control event for the application.

One type of touch interaction that may be detected is a squeeze pressure with which the apparatus is being squeezed. The squeeze pressure may be based, at least in part, on the touch pressure associated with at least two members of the set of points. In one embodiment, the touch pressure of points that are on opposite sides of an apparatus may be considered. Once the squeeze pressure has been identified, method 1500 may control the apparatus based on the squeeze pressure. For example, a squeeze may be used to selectively answer a phone call (e.g., one squeeze means ignore, two squeezes means answer). A squeeze could also be used to hang up a phone call. This type of squeeze responsiveness may facilitate using a phone with just one hand. Squeeze pressure may also be used to control other actions. For example, squeezing the phone may adjust the volume for the phone, may adjust the brightness of a screen on the phone, or may adjust another property.

The action taken in response to a squeeze may depend on the application running on the apparatus. For example, when a first video game is being played, the squeeze pressure may be used to control the intensity of an effect (e.g., strength of punch, range of magical spell) in the game while when a second video game is being played a squeeze may be used to spin a control or object (e.g., slot machine, roulette wheel).

Some gestures or actions may occur partially on a display and partially on an edge interface (e.g., touch sensitive region that is not part of the display). Thus, in one embodiment, detecting the action at 1540 may include detecting an action performed partially on a touch sensitive input region on the apparatus and partially on the display. Like an action performed entirely on the touch interface or entirely on the display, this hybrid action may be characterized to produce a characterization data that describes a duration of the action, a location of the action, a pressure of the action, or a direction of the action. The apparatus may then be selectively controlled based, at least in part, on the hybrid action or the characterization data.

While FIGS. 15 and 16 illustrate various actions occurring in serial, it is to be appreciated that various actions illustrated in FIGS. 15 and 16 could occur substantially in parallel. By way of illustration, a first process could analyze touch and hover events for a display, a second process could analyze touch events occurring off the display, and a third process could control the appearance or operation of the apparatus based on the events. While three processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer) cause the machine to perform methods described or claimed herein including method 1500. While executable instructions associated with the listed methods are described as being stored on a computer-readable storage medium, it is to be appreciated that executable instructions associated with other example methods described or claimed herein may also be stored on a computer-readable storage medium. In different embodiments, the example methods described herein may be triggered in different ways. In one embodiment, a method may be triggered manually by a user. In another example, a method may be triggered automatically.

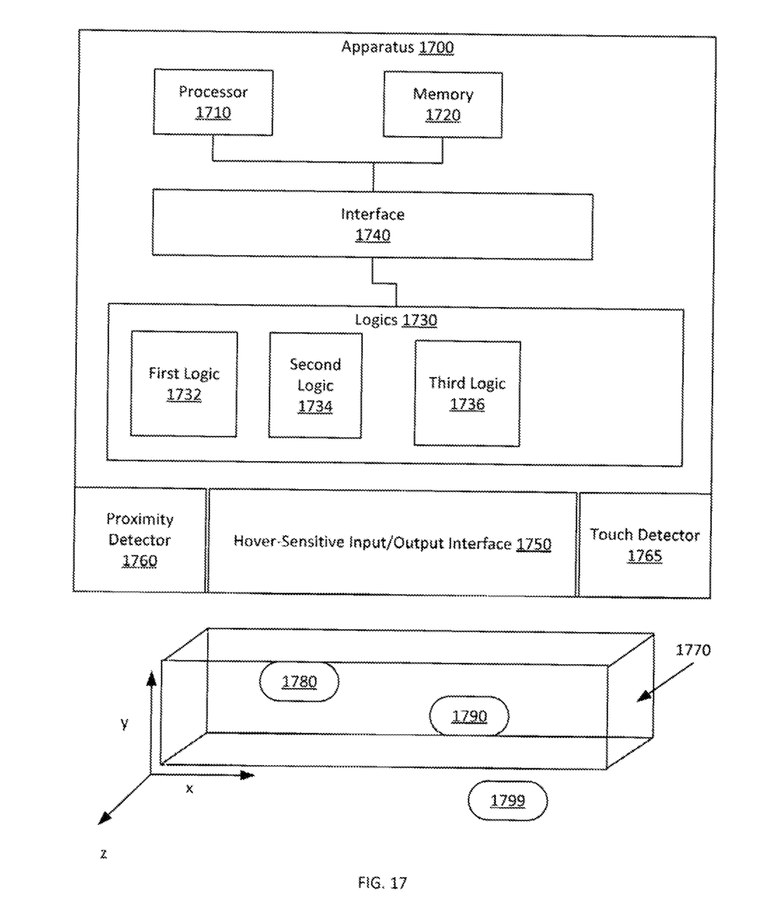

FIG. 17 illustrates an apparatus 1700 that responds to grip detection. In one example, the apparatus 1700 includes an interface 1740 configured to connect a processor 1710, a memory 1720, a set of logics 1730, a proximity detector 1760, a touch detector 1765, and a hover-sensitive i/o interface 1750. Elements of the apparatus 1700 may be configured to communicate with each other, but not all connections have been shown for clarity of illustration. The hover-sensitive input/output interface 1760 may be configured to report multiple (x,y,z) measurements for objects in a region above the input/output interface 1750. The set of logics 1730 may be configured to determine and respond to how the apparatus 1700 is being held. The set of logics 1730 may provide an event drive model.

The hover-sensitive input/output interface 1750 may be configured to detect a first point at which the apparatus 1700 is being held. The touch detector 1765 may support a touch interface that is configured to detect a second point at which the apparatus 1700 is being held. The touch interface may be configured to detect touches in locations other than the hover-sensitive input/output interface 1750.

In computing, an event is an action or occurrence detected by a program that may be handled by the program. Typically, events are handled synchronously with the program flow. When handled synchronously, the program may have a dedicated place where events are handled. Events may be handled in, for example, an event loop. Typical sources of events include users pressing keys, touching an interface, performing a gesture, or taking another user interface action. Another source of events is a hardware device such as a timer. A program may trigger its own custom set of events. A computer program or apparatus that changes its behavior in response to events is said to be event-driven.

The proximity detector 1760 may detect an object 1780 in a hover-space 1770 associated with the apparatus 1700. The proximity detector 1760 may also detect another object 1790 in the hover-space 1770. The hover-space 1770 may be, for example, a three dimensional volume disposed in proximity to the i/o interface 1750 and in an area accessible to the proximity detector 1760. The hover-space 1770 has finite bounds. Therefore the proximity detector 1760 may not detect an object 1799 that is positioned outside the hover-space 1770. A user may place a digit in the hover-space 1770, may place multiple digits in the hover-space 1770, may place their hand in the hover-space 1770, may place an object (e.g., stylus) in the hover-space 1770, may make a gesture in the hover-space 1770, may remove a digit from the hover-space 1770, or take other actions. Apparatus 1700 may also detect objects that touch i/o interface 1750. The entry of an object into hover space 1770 may produce a hover-enter event. The exit of an object from hover space 1770 may produce a hover-exit event. The movement of an object in hover space 1770 may produce a hover-point move event. When an object comes in contact with the interface 1750, a hover to touch transition event may be generated. When an object that was in contact with the interface 1750 loses contact with the interface 1750, then a touch to hover transition event may be generated. Example methods and apparatus may interact with these and other hover and touch events.

Apparatus 1700 may include a first logic 1732 that is configured to handle a first hold event generated by the hover-sensitive input/output interface. The first hold event may be generated in response to, for example, a hover or touch event that is associated with holding, gripping, or supporting the apparatus 1700 instead of operating the apparatus. For example, a hover enter followed by a hover approach followed by a persistent touch event that is not on a user interface element may be associated with a finger coming in contact with the apparatus 1700 for the purpose of holding the apparatus. The first hold event may include information about an action that caused the hold event. For example, the event may include data that identifies a location where an action occurred to cause the hold event, a duration of a first action that caused the first hold event, or other information.

Apparatus 1700 may include a second logic 1734 that is configured to handle a second hold event generated by the touch interface. The second hold event may be generated in response to, for example, a persistent touch or set of touches that are not associated with any control. The second hold event may include information about an action that caused the second hold event to be generated. For example, the second hold event may include data describing a location at which the action occurred, a pressure associated with the action, a duration of the action, or other information.

Apparatus 1700 may include a third logic 1736 that is configured to determine a hold parameter for the apparatus 1700. The hold parameter may be determined based, at least in part, on the first point, the first hold event, the second point, or the second hold event. The hold parameter may identify, for example, whether the apparatus 1700 is being held in a right hand grip, a left hand grip, a two hands grip, or a no hands grip. The hold parameter may also identify, for example, an edge of the apparatus 1700 that is the current top edge of the apparatus 1700.

The third logic 1736 may also be configured to generate a control event based, at least in part, on the hold parameter. The control event may control, for example, a property of the hover-sensitive input/output interface 1750, a property of the touch interface, or a property of the apparatus 1700.

In one embodiment, the property of the hover-sensitive input/output interface 1750 that is manipulated may be the size, shape, color, location, or sensitivity of a user interface element displayed on the hover-sensitive input/output interface 1750. The property of the hover-sensitive input/output interface 1750 may also be, for example, the brightness of the hover-sensitive input/output interface 1750, a sensitivity of a portion of the hover-sensitive input/output interface 1750, or other property.

In one embodiment, the property of the touch interface that is manipulated is a location of an active touch sensor, a location of an inactive touch sensor, or a function associated with a touch on a touch sensor. Recall that apparatus 1700 may have a plurality (e.g., 16, 128) of touch sensors and that different sensors may be (in)active based on how the apparatus 1700 is being gripped. Thus, the property of the touch interface may identify which of the plurality of touch sensors are active and what touches on the active sensors mean. For example, a touch on a sensor may perform a first function when the apparatus 1700 is held in a right hand grip with a certain edge on top but a touch on the sensor may perform a second function when the apparatus 1700 is in a left hand grip with a different edge on top.

In one embodiment, the property of the apparatus 1700 is a gross control. For example, the property may be a power level (e.g., on, off, sleep, battery saver) of the apparatus 1700. In another embodiment, the property of apparatus may be a finer grained control (e.g., a radio transmission range of a transmitter on the apparatus 1700, volume of a speaker on the apparatus 1700).

In one embodiment, the hover-sensitive input/output interface 1750 may display a user interface element. In this embodiment, the first hold event may include information about a location or duration of a first action that caused the first hold event. Different touch or hover events at different locations on the interface 1750 and of different durations may be intended to produce different results. Therefore, the control event generated by the third logic 1736 may manipulate a size, shape, color, function, or location of the user interface element based on the first hold event. Thus, a button may be relocated, resized, recolored, re-sensitized, or repurposed based on where or how the apparatus 1700 is being held or touched.

In one embodiment, the touch interface may provide a touch control. In this embodiment, the second hold event may include information about a location, pressure, or duration of a second action that caused the second hold event. Different touch events on the touch interface may be intended to produce different results. Therefore, the control event generated by the third logic 1736 may manipulate a size, shape, function, or location of a touch control based on the second event. Thus, a non-displayed touch control may be relocated, resized, re-sensitized, repurposed based on how apparatus 1700 is being held or touched.

Apparatus 1700 may include a memory 1720. Memory 1720 can include non-removable memory or removable memory. Non-removable memory may include random access memory (RAM), read only memory (ROM), flash memory, a hard disk, or other memory storage technologies. Removable memory may include flash memory, or other memory storage technologies, such as “smart cards,” Memory 1720 may be configured to store touch point data, hover point data, touch action data, event data, or other data.

Apparatus 1700 may include a processor 1710. Processor 1710 may be, for example, a signal processor, a microprocessor, an application specific integrated circuit (ASIC), or other control and processing logic circuitry for performing tasks including signal coding, data processing, input/output processing, power control, or other functions. Processor 1710 may be configured to interact with the logics 1730. In one embodiment, the apparatus 1700 may be a general purpose computer that has been transformed into a special purpose computer through the inclusion of the set of logics 1730.

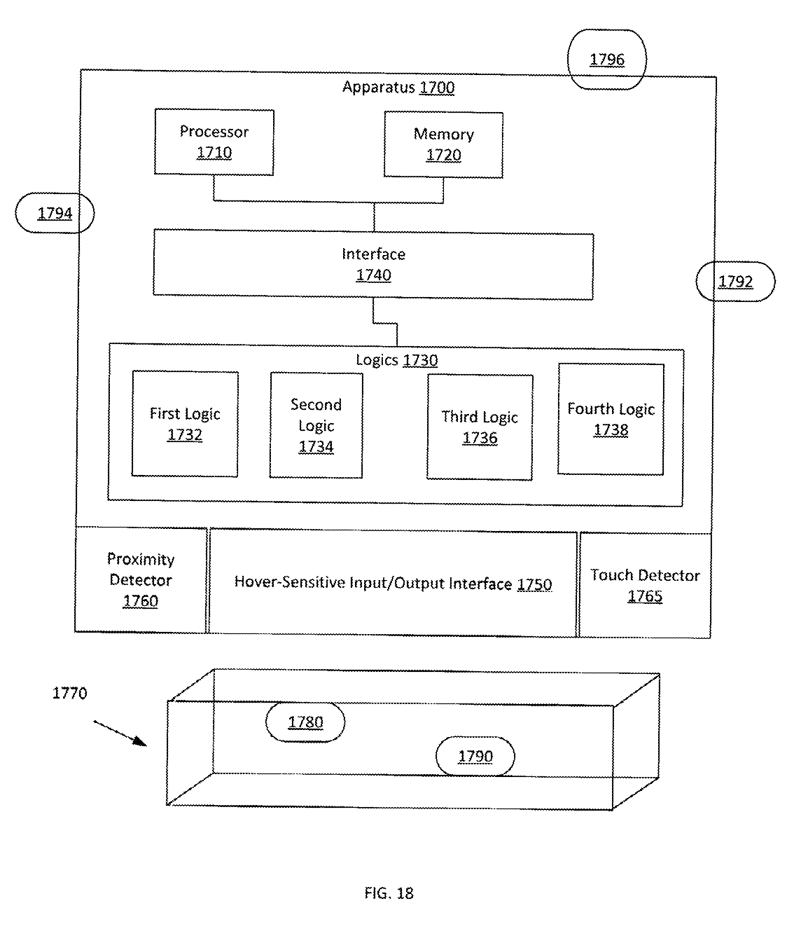

FIG. 18 illustrates another embodiment of apparatus 1700 (FIG. 17). This embodiment of apparatus 1700 includes a fourth logic 1738 that is configured to reconfigure apparatus 1700 based on how apparatus 1700 is being used rather than based on how apparatus 1700 is being held. In this embodiment, the first logic 1732 may be configured to handle a hover control event. The hover control event may be generated in response to, for example, a tap, a multi-tap, a swipe, a gesture, or other action. The hover control event differs from the first hold event in that the first event is associated with how the apparatus 1700 is being held while the hover control event is associated with how the apparatus 1700 is being used. The second logic 1734 may be configured to handle a touch control event. The touch control event may be generated in response to, for example, a tap, a multi-tap, a swipe, a squeeze, or other action.

The hover control event and the touch control event may be associated with how the apparatus 1700 is being used. Therefore, in one embodiment, the fourth logic 1738 may be configured to generate a reconfigure event based, at least in part, on the hover control event or the touch control event. The reconfigure event may manipulate the property of the hover-sensitive input/output interface, the property of the touch interface, or the property of the apparatus. Thus, a default configuration may be reconfigured based on how the apparatus 1700 is being held and the reconfiguration may be further reconfigured based on how the apparatus 1700 is being used.

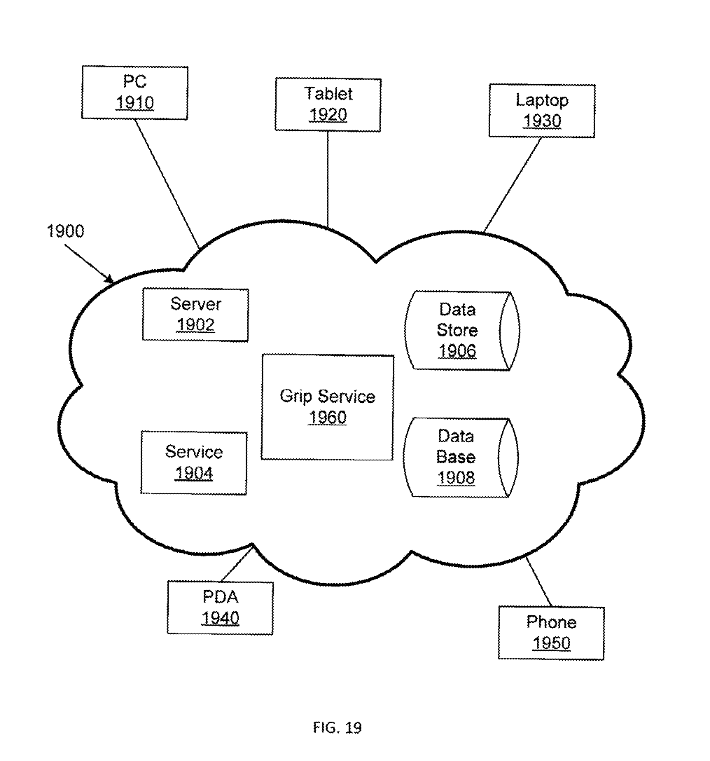

FIG. 19 illustrates an example cloud operating environment 1900. A cloud operating environment 1900 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 19 illustrates an example grip service 1960 residing in the cloud. The grip service 1960 may rely on a server 1902 or service 1904 to perform processing and may rely on a data store 1906 or database 1908 to store data. While a single server 1902, a single service 1904, a single data store 1906, and a single database 1908 are illustrated, multiple instances of servers, services, data stores, and databases may reside in the cloud and may, therefore, be used by the grip service 1960.

FIG. 19 illustrates various devices accessing the grip service 1960 in the cloud. The devices include a computer 1910, a tablet 1920, a laptop computer 1930, a personal digital assistant 1940, and a mobile device (e.g., cellular phone, satellite phone) 1950. It is possible that different users at different locations using different devices may access the grip service 1960 through different networks or interfaces. In one example, the grip service 1960 may be accessed by a mobile device 1950. In another example, portions of grip service 1960 may reside on a mobile device 1950. Grip service 1960 may perform actions including, for example, detecting how a device is being held, which digit(s) are interacting with a device, handling events, producing events, or other actions. In one embodiment, grip service 1960 may perform portions of methods described herein (e.g., method 1500, method 1600).

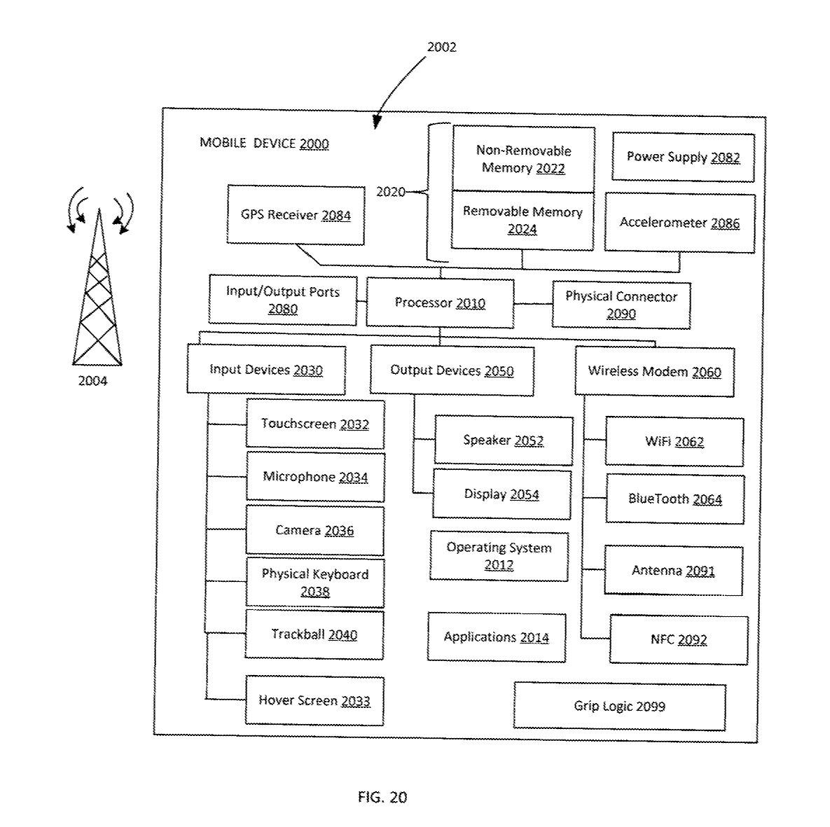

FIG. 20 is a system diagram depicting an exemplary mobile device 2000 that includes a variety of optional hardware and software components, shown generally at 2002. Components 2002 in the mobile device 2000 can communicate with other components, although not all connections are shown for ease of illustration. The mobile device 2000 may be a variety of computing devices (e.g., cell phone, smartphone, handheld computer, Personal Digital Assistant (PDA), etc.) and may allow wireless two-way communications with one or more mobile communications networks 2004, such as a cellular or satellite networks.

Mobile device 2000 can include a controller or processor 2010 (e.g., signal processor, microprocessor, application specific integrated circuit (ASIC), or other control and processing logic circuitry) for performing tasks including signal coding, data processing, input/output processing, power control, or other functions. An operating system 2012 can control the allocation and usage of the components 2002 and support application programs 2014. The application programs 2014 can include mobile computing applications (e.g., email applications, calendars, contact managers, web browsers, messaging applications), grip applications, or other applications.

Mobile device 2000 can include memory 2020. Memory 2020 can include non-removable memory 2022 or removable memory 2024. The non-removable memory 2022 can include random access memory (RAM), read only memory (ROM), flash memory, a hard disk, or other memory storage technologies. The removable memory 2024 can include flash memory or a Subscriber Identity Module (SIM) card, which is known in GSM communication systems, or other memory storage technologies, such as “smart cards,” The memory 2020 can be used for storing data or code for running the operating system 2012 and the applications 2014. Example data can include grip data, hover point data, touch point data user interface element state, web pages, text, images, sound files, video data, or other data sets to be sent to or received from one or more network servers or other devices via one or more wired or wireless networks. The memory 2020 can store a subscriber identifier, such as an International Mobile Subscriber Identity (IMSI), and an equipment identifier, such as an International Mobile Equipment Identifier (IMEI). The identifiers can be transmitted to a network server to identify users or equipment.

The mobile device 2000 can support one or more input devices 2030 including, but not limited to, a touchscreen 2032, a hover screen 2033, a microphone 2034, a camera 2036, a physical keyboard 2038, or trackball 2040. While a touch screen 2032 and a hover screen 2033 are described, in one embodiment a screen may be both touch and hover-sensitive. The mobile device 2000 may also include touch sensors or other sensors positioned on the edges, sides, top, bottom, or back of the device 2000. The mobile device 2000 may also support output devices 2050 including, but not limited to, a speaker 2052 and a display 2054. Other possible input devices (not shown) include accelerometers (e.g., one dimensional, two dimensional, three dimensional). Other possible output devices (not shown) can include piezoelectric or other haptic output devices. Some devices can serve more than one input/output function. For example, touchscreen 2032 and display 2054 can be combined in a single input/output device.

The input devices 2030 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice and speech, vision, touch, gestures, and machine intelligence. Other examples of a NUI include motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (electro-encephalogram (EEG) and related methods). Thus, in one specific example, the operating system 2012 or applications 2014 can comprise speech-recognition software as part of a voice user interface that allows a user to operate the device 2000 via voice commands.

A wireless modem 2060 can be coupled to an antenna 2091. In some examples, radio frequency (RF) filters are used and the processor 2010 need not select an antenna configuration for a selected frequency band. The wireless modem 2060 can support two-way communications between the processor 2010 and external devices. The modem 2060 is shown generically and can include a cellular modem for communicating with the mobile communication network 2004 and/or other radio-based modems (e.g., Bluetooth 2064 or Wi-Fi 2062). The wireless modem 2060 may be configured for communication with one or more cellular networks, such as a Global system for mobile communications (GSM) network for data and voice communications within a single cellular network, between cellular networks, or between the mobile device and a public switched telephone network (PSTN). Mobile device 2000 may also communicate locally using, for example, near field communication (NFC) element 2092.

The mobile device 2000 may include at least one input/output port 2080, a power supply 2082, a satellite navigation system receiver 2084, such as a Global Positioning System (GPS) receiver, an accelerometer 2086, or a physical connector 2090, which can be a Universal Serial Bus (USB) port, IEEE 1394 (FireWire) port, RS-232 port, or other port. The illustrated components 2002 are not required or all-inclusive, as other components can be deleted or added.

Mobile device 2000 may include a grip logic 2099 that is configured to provide a functionality for the mobile device 2000. For example, grip logic 2099 may provide a client for interacting with a service (e.g., service 1960, FIG. 19). Portions of the example methods described herein may be performed by grip logic 2099. Similarly, grip logic 2099 may implement portions of apparatus described herein.

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable storage medium”, as used herein, refers to a medium that stores instructions or data. “Computer-readable storage medium” does not refer to propagated signals. A computer-readable storage medium may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage medium may include, but are not limited to, a floppy disk, a flexible disk, a hard disk, a magnetic tape, other magnetic medium, an application specific integrated circuit (ASIC), a compact disk (CD), a random access memory (RAM), a read only memory (ROM), a memory chip or card, a memory stick, and other media from which a computer, a processor or other electronic device can read.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
identifying a non-empty set of points where an apparatus is being gripped, the apparatus being a portable device configured with a touch or hover-sensitive display;
determining a grip context based on the set of points, and
controlling the operation or appearance of the apparatus based, at least in part, on the grip context.

2. The method of claim 1, where the grip context identifies whether the apparatus is being gripped in a right hand, in a left hand, by a left hand and a right hand, or by no hands.

3. The method of claim 2, where the grip context identifies whether the apparatus is being gripped in a portrait orientation or in a landscape orientation.

4. The method of claim 3, where the set of points are identified from first information provided by the display or where the set of points are identified from second information provided by a plurality of touch sensors, where the plurality of touch sensors are located on the front, side, or back of the apparatus, and where the touch sensors are not part of the display.

5. The method of claim 4, where the first information includes a touch location, a touch duration, or a touch pressure.

6. The method of claim 5, where the first information identifies a member of the set of points as being associated with a finger, a thumb, a palm, or a surface.

7. The method of claim 3, where controlling the operation or appearance of the apparatus includes controlling the operation or appearance of the display based, at least in part, on the set of points and the grip context.

8. The method of claim 7, where controlling the operation or appearance of the display includes manipulating a position of a user interface element displayed on the display, manipulating a color of the user interface element, manipulating a size of the user interface element, manipulating a shape of the user interface element, manipulating a sensitivity of the user interface element, controlling whether the display presents information in a portrait or landscape orientation, or changing the sensitivity of a portion of the display.

9. The method of claim 1, where controlling the operation of the apparatus includes controlling the operation of a physical control on the apparatus based, at least in part, on the set of points and the grip context, where the physical control is not part of the display.

10. The method of claim 3, comprising:
detecting an action performed on a touch sensitive input region on the apparatus, where the action is a tap, a multi-tap, a swipe, or a squeeze, and where the touch sensitive input region is not part of the display;
characterizing the action to produce a characterization data that describes a duration of the action, a location of the action, a pressure of the action, or a direction of the action, and
selectively controlling the apparatus based, at least in part, on the action or the characterization data.

11. The method of claim 10, where selectively controlling the apparatus includes controlling an appearance of the display, controlling an operation of the display, controlling an operation of the touch sensitive input region, controlling an application running on the apparatus, generating a control event for the application, or controlling a component of the apparatus.

12. The method of claim 5, comprising:
detecting a squeeze pressure with which the apparatus is being squeezed based, at least in part, on the touch pressure associated with at least two members of the set of points, and
controlling the apparatus based, at least in part, on the squeeze pressure, to:
selectively answer a phone call;
selectively adjust a volume for the apparatus;
selectively adjust a brightness of the display, or
selectively control an intensity of an effect in a video game being played on the apparatus.

13. The method of claim 1, comprising:
detecting an action performed partially on a touch sensitive input region on the apparatus and partially on the display, where the touch sensitive input region is not part of the display,
characterizing the action to produce a characterization data that describes a duration of the action, a location of the action, a pressure of the action, or a direction of the action, and
selectively controlling the apparatus based, at least in part, on the action or the characterization data.

14. A computer-readable storage medium storing computer-executable instructions that when executed by a computer cause the computer to perform a method, the method comprising:
identifying a non-empty set of points where an apparatus is being gripped, the apparatus being a portable device configured with a touch or hover-sensitive display, where the set of points are identified from first information provided by the display or where the set of points are identified from second information provided by a plurality of touch sensors, where the plurality of touch sensors are located on the front, side, or back of the apparatus, and where the touch sensors are not part of the display, where the first information includes a touch location, a touch duration, or a touch pressure, and where the first information identifies a member of the set of points as being associated with a finger, a thumb, a palm, or a surface;
determining a grip context based on the set of points, where the grip context identifies whether the apparatus is being gripped in a right hand, in a left hand, by a left hand and a right hand, or by no hands, and where the grip context identifies whether the apparatus is being gripped in a portrait orientation or in a landscape orientation,
controlling the operation or appearance of the apparatus based, at least in part, on the grip context,
where controlling the operation or appearance of the apparatus includes controlling the operation or appearance of the display based, at least in part, on the set of points and the grip context,
where controlling the operation or appearance of the display includes manipulating a position of a user interface element displayed on the display, manipulating a color of the user interface element, manipulating a size of the user interface element, manipulating a shape of the user interface element, manipulating a sensitivity of the user interface element, controlling whether the display presents information in a portrait or landscape orientation, or changing the sensitivity of a portion of the display,
where controlling the operation of the apparatus includes controlling the operation of a physical control on the apparatus based, at least in part, on the set of points and the grip context, where the physical control is not part of the display,
detecting an action performed on a touch sensitive input region on the apparatus or on the display, where the touch sensitive input region is not part of the display, characterizing the action to produce a characterization data that describes a duration of the action, a location of the action, a pressure of the action, or a direction of the action, and selectively controlling the apparatus based, at least in part, on the action or the characterization data, where selectively controlling the apparatus includes controlling an appearance of the display, controlling an operation of the display, controlling an operation of the touch sensitive input region, controlling an application running on the apparatus, generating a control event for the application, or controlling a component of the apparatus;
and
detecting a squeeze pressure with which the apparatus is being squeezed based, at least in part, on the touch pressure associated with at least two members of the set of points, and controlling the apparatus based, at least in part, on the squeeze pressure, to:
selectively answer a phone call;
selectively adjust a volume for the apparatus;
selectively adjust a brightness of the display, or
selectively control an intensity of an effect in a video game being played on the apparatus.

15. An apparatus, comprising:
a processor;
a hover-sensitive input/output interface configured to detect a first point at which the apparatus is being held,
a touch interface configured to detect a second point at which the apparatus is being held, the touch interface being configured to detect touches in locations other than the hover-sensitive input/output interface;
a memory;
a set of logics configured to determine and respond to how the apparatus is being held; and
an interface configured to connect the processor, the hover-sensitive input/output interface, the touch interface, the memory, and the set of logics;
the set of logics including:
a first logic configured to handle a first hold event generated by the hover-sensitive input/output interface;
a second logic configured to handle a second hold event generated by the touch interface, and
a third logic configured:
to determine a hold parameter for the apparatus based, at least in part, on the first point, the first hold event, the second point, or the second hold event, where the hold parameter identifies whether the apparatus is being held in a right hand grip, a left hand grip, a two hands grip, or a no hands grip, and where the hold parameter identifies an edge of the apparatus as the current top edge of the apparatus, and
to generate a control event based, at least in part, on the hold parameter, where the control event controls a property of the hover-sensitive input/output interface, a property of the touch interface, or a property of the apparatus.

16. The apparatus of claim 15,
where the property of the hover-sensitive input/output interface is a size of a user interface element displayed on the hover-sensitive input/output interface, a shape of a user interface element displayed on the hover-sensitive input/output interface, a color of a user interface element displayed on the hover-sensitive input/output interface, a location of a user interface element displayed on the hover-sensitive input/output interface, a sensitivity of a user interface element displayed on the hover-sensitive input/output interface, a brightness of the hover-sensitive input/output interface, or a sensitivity of a portion of the hover-sensitive input/output interface,
where the property of the touch interface is a location of an active touch sensor, or a function associated with a touch on a touch sensor, and
where the property of the apparatus is a volume of a speaker on the apparatus, a radio transmission range of a transmitter on the apparatus, or a power level of the apparatus.

17. The apparatus of claim 16,
where the hover-sensitive input/output interface displays a user interface element,
where the first hold event includes information about a location or a duration of a first action that caused the first hold event, and
where the control event generated by the third logic manipulates a size, a shape, a color, a function, or a location of the user interface element based on the first hold event.

18. The apparatus of claim 16,
where the touch interface provides a touch control,
where the second hold event includes information about a location, a pressure, or a duration of a second action that caused the second hold event, and
where the control event generated by the third logic manipulates a size, a shape, a function, or a location of the touch control based on the second hold event.

19. The apparatus of claim 16,
where the hover-sensitive input/output interface displays a user interface element,
where the first hold event includes information about a location or a duration of a first action that caused the first hold event,
where the touch interface provides a touch control,
where the second hold event includes information about a location, a pressure, or a duration of a second action that caused the second hold event,
where the control event generated by the third logic manipulates a size, a shape, a color, a function, or a location of the user interface element based on the first hold event or second hold event, and
where the control event generated by the third logic manipulates a size, a shape, a function, or a location of the touch control based on the first hold event or second hold event.

20. The apparatus of claim 19, comprising a fourth logic,
where the first logic is configured to handle a hover control event,
where the second logic is configured to handle a touch control event, and
where the fourth logic is configured to generate a reconfigure event based, at least in part, on the hover control event or the touch control event, where the reconfigure event manipulates the property of the hover-sensitive input/output interface, the property of the touch interface, or the property of the apparatus.
